(19) United States
(12) Patent Application Publication
(10) Pub. No.: US 2024/0212216 A1
(43) Pub. Date: Jun. 27, 2024

(54) DATA COMPRESSION METHOD AND IMAGE NOISE REDUCTION METHOD

(71) Applicant: Realtek Semiconductor Corp., HsinChu (TW)

(72) Inventor: Dingtian Shi, Suzhou City (CN)

(73) Assignee: Realtek Semiconductor Corp., HsinChu (TW)

(21) Appl. No.: 18/544,460

(22) Filed: Dec. 19, 2023

(30) Foreign Application Priority Data
Dec. 22, 2022 (CN) 202211657521.5

(51) Int. Cl. G06T 9/00; G06T 5/70

(52) U.S. Cl. CPC G06T 9/00; G06T 5/70

(57) ABSTRACT

A data compression method, for compressing at least portion of data of a data group, comprising: defining X sub data groups, wherein each of the sub data groups comprises a portion of the data group; compressing each of the sub data groups via Y compression algorithms, to generate Y compression results for each of the sub data groups, wherein X and Y are positive integers and X is at least 2; selecting a preferred compression algorithm for each of the sub data groups according to corresponding ones of the Y compression results; and compressing the sub data group by the preferred compression algorithm thereof to generate a plurality of compressed data units.

### BACKGROUND OF THE INVENTION

### 1. Field of the Invention

The present invention relates to a data transmission method and an image reduction method, and particularly relates to a data transmission method and an image reduction method which can be more easily performed by hardware and can reduce required buffer space.

### 2. Description of the Prior Art

Video noise reduction is a common video processing method. Video noise reduction can not only filter out the noises in the video and improve the video quality, but also help other video processing tasks such as video compression, object recognition, and frame frequency improvement. For the images captured by devices such as digital cameras, the noise type is usually the additive Gaussian white noise. The conventional methods for eliminating white noises may comprise using a low pass filter and a multi-image averaging method. The multi-image averaging method utilizes the property that the white noise is irrelevant to the strength of original signals and its average value is zero, thus can remove the noise with a good efficiency. The multi-image averaging method requires the hardware to have a certain amount of buffer space for storing the previous one or two frames as reference frames. The more frames that are referenced, the larger the buffer space is required. However, the limited storage space in a conventional system is difficult to provide enough frame buffer space. Moreover, existing image data compression technologies such as MPEG-2, H.264/AVC and other encoding standards have complex logics and high power consumption. These compression techniques are used to provide a better image quality at a low bandwidth, and require complex hardware for processing, thus are not suitable for compressing frame buffer data for image noise reduction.

### SUMMARY OF THE INVENTION

One objective of the present invention is to provide a data compression method which can save required buffer space.

Another objective of the present invention is to provide an image reduction method which can save required buffer space.

One embodiment of the present invention discloses a data compression method, for compressing at least portion of data of a data group, comprising: defining X sub data groups, wherein each of the sub data groups comprises a portion of the data group; compressing each of the sub data groups via Y compression algorithms, to generate Y compression results for each of the sub data groups, wherein X and Y are positive integers and X is at least 2; selecting a preferred compression algorithm for each of the sub data groups according to corresponding ones of the Y compression results; and compressing the sub data group by the preferred compression algorithm thereof to generate a plurality of compressed data units.

Another embodiment of the present invention discloses an image noise reduction method, comprising: defining X sub data groups, wherein each of the sub data groups comprises a portion of the data group; compressing each of the sub data groups via Y compression algorithms, to generate Y compression results for each of the sub data groups, wherein X and Y are positive integers and X is at least 2; selecting a preferred compression algorithm for each of the sub data groups according to corresponding ones of the Y compression results; compressing the sub data group by the preferred compression algorithm thereof to generate a plurality of compressed data units; and decompressing the compressed data units, to generate X reconstructed sub data groups, and performing image noise reduction according to the X reconstructed sub data groups

In view of above-mentioned embodiments, data compression can be performed using a compression algorithm which is simpler, easier to implement with hardware, and has the best performance. Moreover, since the compression is performed for smaller sub data groups (M×N data units), the required buffer space can also be saved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating a data compression method according to one embodiment of the present invention.

FIG. 2 is a schematic diagram illustrating a data compression method and a data decompression method according to one embodiment of the present invention.

FIG. 3 is a schematic diagram illustrating the data compression operation in FIG. 2, according to one embodiment of the present invention.

FIG. 4, FIG. 5 are schematic diagrams illustrating how to set the algorithm indication data, according to different embodiments of the present invention.

FIG. 6 is a schematic diagram illustrating an electronic device which can implement the data compression method provided by the present invention, according to one embodiment of the present invention.

### DETAILED DESCRIPTION

In the following descriptions, several embodiments are provided to explain the concept of the present application. It will be appreciated that the system, the device, the apparatus or the module depicted in following embodiments can be implemented by hardware (ex. circuit) or the combination of hardware and software (ex. a processing unit executing at least one program). The term “first”, “second”, “third” in following descriptions are only for the purpose of distinguishing different one elements, and do not mean the sequence of the elements. For example, a first device and a second device only mean these devices can have the same structure but are different devices.

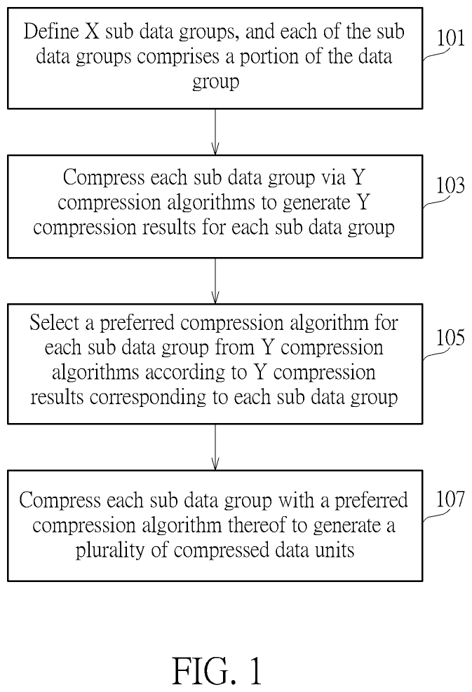

FIG. 1 is a flow chart illustrating a data compression method according to one embodiment of the present invention, which is used to compress at least a portion of a data group and comprises the following steps:

### Step 101

Define X sub data groups, and each of the sub data groups comprises a portion of the data group. In one embodiment, the entire data group is divided into X sub data groups.

### Step 103

Compress each sub data group via Y compression algorithms to generate Y compression results for each sub data group. X and Y are both positive integers and X is at least 2.

For example, the step 103 defines two data groups, the first data group and the second data group, that is, X is 2. Also, the compression algorithms are compression algorithm A, compression algorithm B, compression algorithm C, and compression algorithm D, that is, Y is 4. In such example, 4 compression algorithms are used to process the first data group and the second data group respectively, so the first data group and the second data group respectively have 4 corresponding compression results.

### Step 105

Select a preferred compression algorithm for each sub data group from Y compression algorithms according to Y compression results corresponding to each sub data group. The preferred compression algorithm may be an optimal compression algorithm or a relatively preferred compression algorithm.

Taking step 103 as an example, a preferred compression algorithm for the first data group and a preferred compression algorithm for the second data group are selected from the compression algorithm A, the compression algorithm B, the compression algorithm C and the compression algorithm D, according to the 4 compression results respectively of the first data group and the second data group. For example, the compression algorithm B is selected as the preferred compression algorithm according to the 4 compression results of the first data group, and the compression algorithm C is selected as the preferred compression algorithm according to the 4 compression results of the second data group.

In one embodiment, the compression result comprises an error value generated during the compression process, such as a Sum of Absolute Differences (SAD) or a Sum of Squared Difference (SSD). Step 105 selects a preferred compression algorithm according to the error value. In one embodiment, the preferred compression algorithm is a best compression algorithm that produces the least error value.

### Step 107

Compress each sub data group with a preferred compression algorithm thereof to generate a plurality of compressed data units (e.g., packets). The number of bits of the compressed data unit may be different for different compression algorithms.

The present invention will be described below with other embodiments. In the following embodiments, the data group described in FIG. 1 is an image, and the sub data group is a portion of the image. Each sub data group has M×N pixels, M and N are positive integers. In one embodiment, M is 1, and N is 8 or 16. In the case where the data group is an image and the sub data group is a portion of the image, if the data compression method shown in FIG. 1 is used for an image noise reduction method, this image noise reduction method can further comprise other steps in addition to the steps shown in FIG. 1. These other steps comprise: decompressing the X compressed data units to generate X reconstructed sub data groups, and performing image noise reduction according to the X reconstructed sub data groups. For example, an image averaging method is used for image noise reduction. In such method, at least one image is compressed and temporarily buffered, and then the temporarily buffered image is decompressed as a reference image.

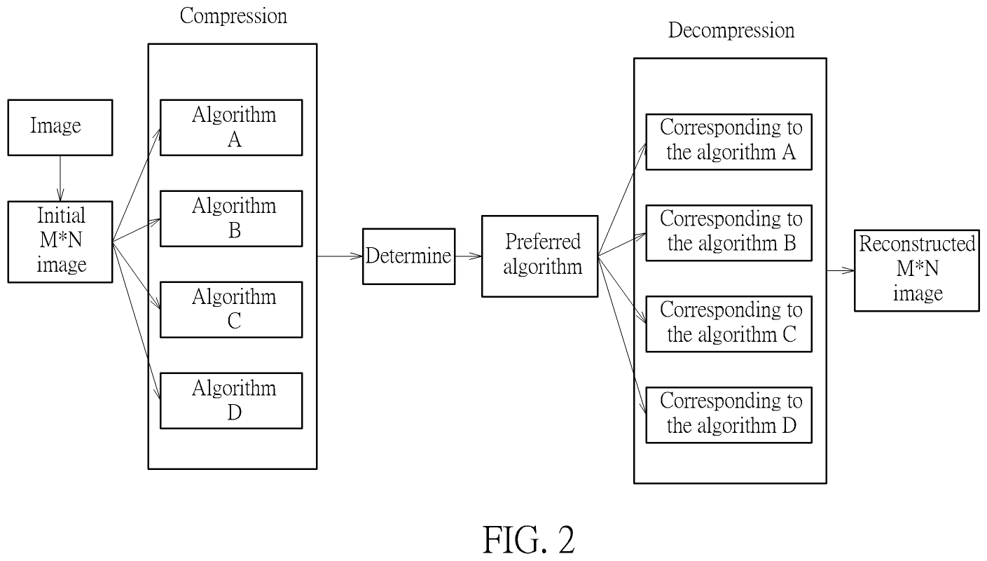

FIG. 2 is a schematic diagram illustrating a data compression method and a data decompression method according to one embodiment of the present invention. In the embodiment of FIG. 2, the entire image (the aforementioned data group) is divided into a plurality of small units for compression, that is, divided into a plurality of image units with a size of M×N pixels (the aforementioned sub data group, hereinafter referred to as the M×N unit). As mentioned above, in one embodiment, M is 1, and N can be 8 or 16. The processing for each M×N unit comprises two parts, namely, a compression operation and a corresponding decompression operation. In the compression operation, four algorithms A, B, C, and D are used to compress the M×N unit first, and each algorithm can be regarded as a mode. Each mode compresses the data and computes the error value by the compression algorithm, such as the aforementioned SAD or SSD. After the compression operations of the four modes are completed, the error values of the same M×N unit in different modes are compared, and the mode with the smallest error value is selected as the final compression method, that is, a preferred compression algorithm will be determined.

It should be noted that the error value can be obtained by subtracting the reconstructed value from the actual value. The reconstructed value means the value obtained by decompressing the compressed data unit. So in order to compute the error value, the actual compression process comprises the decompression operation. In addition, the four algorithms here can be compression algorithms specially designed for certain types of numerical distribution. By this way, the compression algorithms can cover as many numerical distribution types as possible, so as to fully extract data correlation and thus the purpose of reducing the compression error can be achieved. After a preferred compression algorithm is selected, information related to the preferred compression algorithm (or called mode information) is stored in the compressed data of M×N units. When decompressing, information of the preferred compression algorithm is firstly acquired from the compressed data, then perform corresponding decompression, and finally obtain the reconstructed M×N unit.

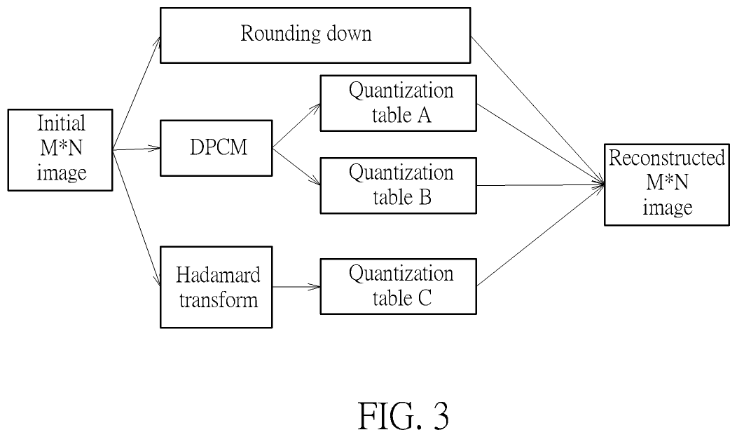

FIG. 3 is a schematic diagram illustrating the data compression operation in FIG. 2, according to one embodiment of the present invention. The compression operation may comprise two parts: transformation and quantization. Transformation comprises obtaining the correlations between different M×N units through a certain form of data conversion. The quantization comprises performing a many-to-one mapping conversion on the transformed data through the quantization step size, so as to achieve the purpose of compression.

Specific examples of transformation and quantization methods will be described below. In the embodiment shown in FIG. 3, the algorithm A uses a rounding down algorithm (or called a rounding method), that is, directly discards some last bits of the original data. For example, in the process of compressing 12-bit raw data into 8-bit data, rounding will be done according to the last four bits of the 12-bit data. When the last four bits are greater than or equal to 8, a fixed bit (e.g., 0x10) value will be added, then the last four bits are discarded. When the last four bits are less than 8, the last four bits are discarded directly. The algorithm B can use a DPCM (Differential pulse-code modulation) algorithm with quantization tables. DPCM is a common encoding method. It uses the previous sample value to predict the new sample, subtract the predicted value from the actual value of the sample to obtain a difference, and then quantify the difference. In one embodiment, the predicted value of the new sample can use the reconstructed value of the previous bit (obtained through the decompression operation in the aforementioned compression process). In some embodiments, the difference is not large, so non-uniform quantization can be used, that is, the quantization step size is small when the difference value is small, and the quantization step size is large when the difference value is large.

The algorithm C also adopts a DPCM with quantization tables. Different from the algorithm B, the quantization step of the quantization table can take other values while using the algorithm C, which greatly expands the range of numerical distribution of DPCM. The algorithm D uses a Hadamard transform algorithm with quantization tables. The Hadamard transform is one of the generalized Fourier transforms, through which the corresponding DC and AC components can be obtained, thereby removing data correlation. Besides, the positive and negative transformations of the Hadamard transformation have the same form, and only subtraction and addition are used, thus the operations of Hadamard transformation are simple and can be easily implemented by hardware. In addition to the Hadamard transform, the afore-mentioned rounding down algorithm and DPCM also have the advantages of simple operations and easy hardware implementation, compared with the complex compression method in the conventional technology.

In one embodiment, the algorithm A described in FIG. 3 can be used as a basic compression method, and when other methods cannot obtain good compression performance through data correlation, the algorithm can be adopted according to the evaluation criteria. For example, the algorithm A is selected when the error values of other algorithms are all higher than an error threshold. Although the algorithm A may lose the compression performance to a certain extent, it does not depend on any correlation of the input data, and can provide a relatively stable compression operation. Both the algorithm B and the algorithm C use the DPCM algorithm. Although the principle of the DPCM algorithm is to subtract the original values back and forth to obtain a relatively small difference in the value range, the difference between the algorithm B and the algorithm C is that different quantization tables can be used. By this way more many-to-one mapping methods can be provided to cover more types of numerical distributions. The algorithm D uses the Hadamard transform algorithm with quantization tables. The algorithm D can obtain the correlation of data in the frequency domain, and then performs quantization, which can better compress the data with strong correlation in the frequency domain.

In addition to the aforementioned steps, the present invention can preprocess the image before compressing the image to increase the efficiency of the compression operation. In one embodiment, before defining the M×N unit, that is, before dividing the image, data of channels of different colors of the image are extracted and rearranged. For example, if the aforementioned image is an initial image that is directly output after being sensed by an image sensor without other processing, the image may have formats such as GRBG, RGGB, BGGR, and GBRG. Taking GRBG as an example, the initial image will be arranged in the order of G, R, B, and G in 2×2 data blocks. Therefore, in this arrangement, the adjacent data, or the M×N units which were allocated later do not completely belong to the same color channel, but the data in the same color channel has a real strong correlation. Therefore, in order to maximize the use of data correlation to improve compression performance, before each M×N data unit is compressed, the initial image is preprocessed, and the data of each of the four channels of GRBG is extracted and then rearrange to ensure that the data in the M×N units all belong to the same color channel.

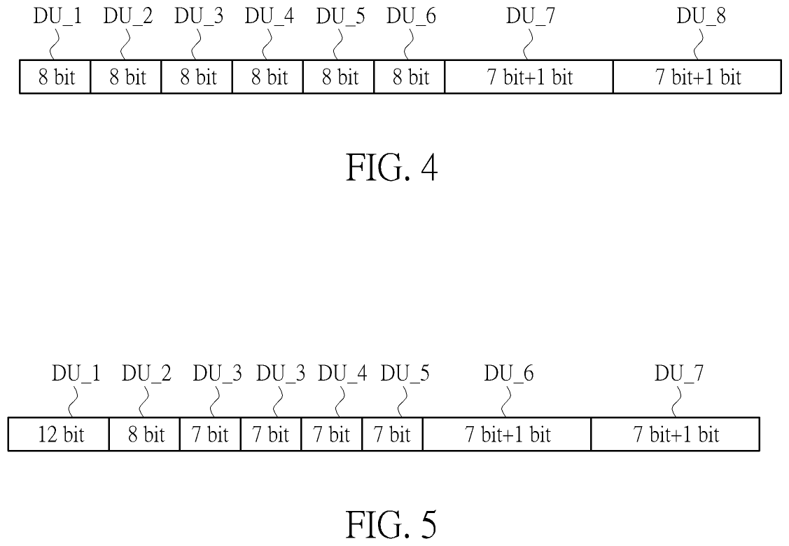

Please refer to FIG. 2 again. In the description of FIG. 2, it is mentioned that the decompression operation is performed corresponding to the algorithm used by each M×N unit. Therefore, in one embodiment, algorithm indication data is provided in the compressed data to indicate which algorithm is used (that is, in which mode to compress), for the subsequent decompression operations. FIG. 4 is a schematic diagram illustrating how to set the algorithm indication data, according to different embodiments of the present invention. In the embodiment of FIG. 4, at least one of the compressed data units is provided with algorithm indication data to indicate which algorithm is used for compression. In the aforementioned embodiments, there are four types of algorithms in total, so the algorithm indication data needs 2 bits to represent. If the aforementioned M is 1 and N is 8, that is, a unit of 1×8 bits is compressed. Each pixel in the initial image is 12 bits, and the capacity requirement of the storage unit is 8 bits per pixel for the compressed data, that is, each compressed data unit has 8 bits. Then, the bit distribution of the compressed data unit generated by the DPCM algorithm can be shown in FIG. 4. In the embodiment of FIG. 4, the compressed data units DU_1-DU_6 all have 8-bit data. The compressed data units DU_7 and DU_8 respectively contain 7-bit data and 1-bit algorithm indication data.

In another embodiment, the compressed data units are divided into a DC component and an AC component, wherein the compressed data unit corresponding to the DC component has a first number of bits and the compressed data unit corresponding to the AC compressed data unit has a second number of bits. The second number is smaller than the first number. The algorithm indication data is set in the compressed data unit corresponding to the AC component to indicate which algorithm is used for compression. In detail, the data compressed by the Hadamard transformation algorithm produce DC components and AC components, and most of the energy is concentrated in the DC components, that is, the first value after transformation is larger. Therefore, in the embodiment shown in FIG. 5, the first compressed data unit DU_1 corresponds to the DC component, thus has more bits (12 bits). The compressed data units DU_1-DU_7 correspond to the AC component, so they have less bits (7 bits or 8 bits). The compressed data units corresponding to the AC components may have the same number of bits or different numbers of bits. The compressed data units DU_6 and DU_7 both have 7-bit data and 1-bit algorithm indication data.

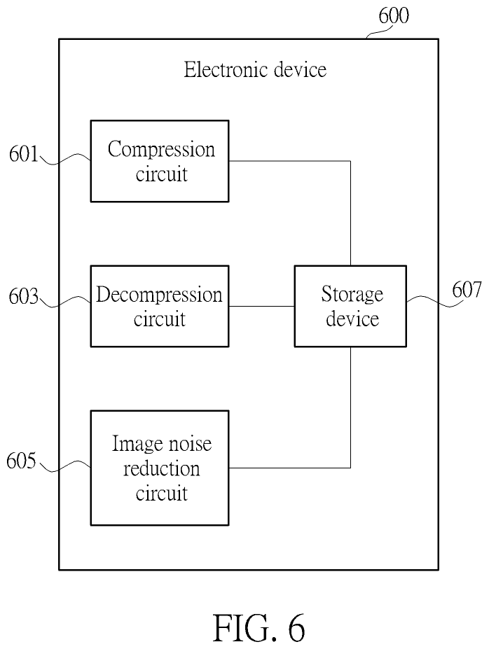

FIG. 6 is a schematic diagram illustrating an electronic device which can implement the data compression method provided by the present invention, according to one embodiment of the present invention. As shown in FIG. 6, the electronic device 600 comprises a compression circuit 601, a decompression circuit 603, an image noise reduction circuit 605 and a storage device 607. The electronic device 600 can be any electronic device, such as a mobile phone, a tablet computer or a desktop computer. The storage device 607 can store at least one program, and can be located outside the electronic device 600 rather than limited to be in the electronic device 600. The compression circuit 601, the decompression circuit 603 and the image noise reduction circuit 605 can read the programs in the storage device 607 to implement the aforementioned compression method, decompression method and image noise reduction method respectively. The electronic device 600 may only comprise at least one of the compression circuit 601, the decompression circuit 603 and the image noise reduction circuit 605 . For example, the electronic device 600 may only comprise the compression circuit 601, or comprises the compression circuit 601 and the decompression circuit 603. In one embodiment, the compression circuit 601, the decompression circuit 603 and the image noise reduction circuit 605 may be implemented by a processing circuit (such as a microprocessor).

In view of above-mentioned embodiments, data compression can be performed using a compression algorithm which is simpler, easier to implement with hardware, and has the best performance. Moreover, since the compression is performed for smaller sub data groups (M×N data units), the required buffer space can also be saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data compression method, for compressing at least portion of data of a data group, comprising:
defining X sub data groups, wherein each of the sub data groups comprises a portion of the data group;
compressing each of the sub data groups via Y compression algorithms, to generate Y compression results for each of the sub data groups, wherein X and Y are positive integers and X is at least 2;
selecting a preferred compression algorithm for each of the sub data groups according to corresponding ones of the Y compression results; and
compressing the sub data group by the preferred compression algorithm thereof to generate a plurality of compressed data units.

2. The data compression method of claim 1, wherein the data group is an image and the sub data groups are respectively a portion of the image, wherein each of the sub data groups comprises M×N pixels, where M and N are positive integers.

3. The data compression method of claim 2, wherein the Y compression algorithms comprises rounding down algorithm.

4. The data compression method of claim 2, wherein the Y compression algorithms comprises a Hadamard transform algorithm.

5. The data compression method of claim 2, wherein the Y compression algorithms comprises a DPCM (Differential pulse-code modulation) algorithm.

6. The data compression method of claim 5, wherein the Y compression algorithms comprises at least two of DPCM algorithms, wherein each of the DPCM algorithms has different algorithms quantization tables.

7. The data compression method of claim 2, wherein M is 1, N is 8 or 16.

8. The data compression method of claim 2, further comprising:
subtracting and rearranging data of channels for different colors of the image before defining the sub data groups.

9. The data compression method of claim 1, further comprising:
providing algorithm indication data in at least one of the compressed data units, to indicate which one of the algorithms is utilized for compressing.

10. The data compression method of claim 1, further comprising:
classifying the compressed data units to a DC component and an AC component, wherein the compressed data units corresponding to the DC component has a first number of bits, and the compressed data units corresponding to the AC component has a second number of bits, wherein the second number is smaller than the first number; and
providing algorithm indication data in the compressed data units corresponding to the AC component, to indicate which one of the algorithms is utilized for compressing.

11. An image noise reduction method, comprising:
defining X sub data groups, wherein each of the sub data groups comprises a portion of the data group;
compressing each of the sub data groups via Y compression algorithms, to generate Y compression results for each of the sub data groups, wherein X and Y are positive integers and X is at least 2;
selecting a preferred compression algorithm for each of the sub data groups according to corresponding ones of the Y compression results;
compressing the sub data group by the preferred compression algorithm thereof to generate a plurality of compressed data units; and
decompressing the compressed data units, to generate X reconstructed sub data groups, and performing image noise reduction according to the X reconstructed sub data groups.

12. The image noise reduction method of claim 11, wherein each of the sub data groups comprises M×N pixels, where M and N are positive integers.

13. The image noise reduction method of claim 12, wherein M is 1, N is 8 or 16.

14. The image noise reduction method of claim 11, wherein the Y compression algorithms comprises rounding down algorithm.

15. The image noise reduction method of claim 11, wherein the Y compression algorithms comprises a Hadamard transform algorithm.

16. The image noise reduction method of claim 11, wherein the Y compression algorithms comprises a DPCM algorithm.

17. The image noise reduction method of claim 15, wherein the Y compression algorithms comprises at least two of DPCM algorithms, wherein each of the DPCM algorithms has different algorithms quantization tables.

18. The image noise reduction method of claim 11, further comprising:
subtracting and rearranging data of channels for different colors of the image before defining the sub data groups, to ensure data in an identical one of the sub data groups belong to an identical one of the channels.

19. The image noise reduction method of claim 11, further comprising:
providing algorithm indication data in at least one of the compressed data units, to indicate which one of the algorithms is utilized for compressing.

20. The image noise reduction method of claim 11, further comprising:
classifying the compressed data units to a DC component and an AC component, wherein the compressed data units corresponding to the DC component has a first number of bits, and the compressed data units corresponding to the AC component has a second number of bits, wherein the second number is smaller than the first number; and
providing algorithm indication data in the compressed data units corresponding to the AC component, to indicate which one of the algorithms is utilized for compressing.
